(19) United States
(12) Patent Application Publication
(10) Pub. No.: US 2005/0177405 A1
(43) Pub. Date: Aug. 11, 2005

(54) Method and apparatus for enhancing influence

(76) Inventor: Julie Ann Turner, Plano, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 10/872,918

(22) Filed: Jun. 21, 2004

Related U.S. Application Data
(60) Provisional application No. 60/543,851, filed on Feb. 11, 2004.

(51) Int. Cl. G06F 17/60

(52) U.S. Cl. 705/7

(57) ABSTRACT

A system, methods and apparatus for use in planning, preparing, setting up, facilitating, conducting and concluding an event where attendees expand their sphere of influence by engaging in frank dialogue sessions on self-selected topics is provided. Apparatus for enabling the attendees to self-select the topics on which they will conduct dialogue is provided. Apparatus for facilitating autonomous dialogue sessions using game-like tools and rules is described, and a method of conducting the dialogue sessions to assure full participation and to enhance the frank exchange of views among diverse groups is provided. Apparatus in the form of a kit for the facilitation of the events, and utilizing the system and a kit for the participant-directed dialogue sessions, is also provided.

### PRIORITY CLAIM

This application claims priority to U.S. Provisional Application 60/543,851, filed Feb. 11, 2004, entitled “A Method And Apparatus For Enhancing Influence.”

### FIELD OF INVENTION

This invention relates to an apparatus, method and structured program for enhancing the influence of individuals in a group or community. For purposes of this description, influence is defined as the number, breadth and depth of connections or relationships with other diverse and well-connected individuals. The purpose of enhancing the influence of individuals within a group, or across a community, is to increase the collective potential for that group or community to move toward shared goals. Methods of the invention enhance influence by creating an event at which certain processes are followed for enabling and enhancing the dialogue exchanged between individuals each having diverse backgrounds and each having a certain ability to influence certain groups and individuals; the methods increase exchanges between these individuals so as to enable the collective influence of the individuals engaged in a free exchange of ideas to be expanded, to include groups and individuals across social, economic, professional, geographic, cultural, religious and professional boundaries that otherwise, the individuals would be unable to influence.

### BACKGROUND

In order to have influence and to begin participating in community or group efforts to produce change or future action, it is desirable to reach groups and individuals outside of an individual's normal scope, or “orbit,” of influence. An individual's “orbit of influence” as defined here encompasses those persons or groups where the individual has membership or standing so as to be able to express a viewpoint or position and to influence others in that group to accept, adopt or at least listen to, that position. Many community leaders and members have influence in an orbit comprising mostly other people within their chosen profession, for example, social groups, governmental entities, or industry groups. Fewer people can influence persons or groups they have little or no prior contact with; for example, an industry leader may have little influence over a community group or a neighborhood organization. A religious leader may have little contact with and therefore little influence over a group of professionals in industry, or members of a particular profession such as law or medicine.

Many individuals participate in meetings designed to exchange ideas and engage in dialogue between and among members of a particular group. For example, a bar association or a medical association may have a monthly meeting where plans are made for the group, committees and subcommittees are formed to study possible actions, recommendations are made back to the main body, perhaps roundtables or luncheon or breakfast meetings are scheduled. Sometimes, certain leaders from outside of the group may be called on to speak to the group and the group may ask questions, for example a mayor or congressional member may be asked to speak on a particular topic to the group. A religious or neighborhood leader may speak on a particular topic, perhaps addressing a particular event or concern such as crime, or school quality. A nonprofit or charitable leader may speak in order to solicit funds or increase volunteerism from within the members of the professional group. These communications are primarily monologues or lectures, and, while useful, do not create additional influence or dialogue across group boundaries or among the vast members of the group and among members of other groups outside the original group.

Techniques for conducting group meetings to enhance dialogue exist in the prior art. In a group meeting, breakout sessions of smaller groups may be scheduled to try to get individuals to participate and express their viewpoints. Team-building sessions including competitive game or role playing may be scheduled within the confines of a larger meeting in order to attempt to gain more input from individual members. “Skip-level” meetings may be scheduled to enable lower ranking members of a group or organization to have some dialogue with leaders or managers who may rank far above them. Cross-functional meetings are often used within corporate structures to encourage communications between groups who are otherwise normally structurally isolated, for example, a quality control group may have a cross-functional meeting with a production group or a design group to enable certain topics of mutual interest to be discussed. Various methods for encouraging otherwise passive or reluctant individuals to participate in the meetings are used, such as “off-site” meetings away from the normal office setting, or incorporating physical challenges such as mountaineering or pathfinding challenges in an outdoor environment, golf tournaments, fishing tournaments and the like.

While these prior art approaches have some usefulness in gaining additional perspectives and dialogue within a group, they fail to address the need to gain influence and exchange viewpoints across and among diverse groups. Many problems which need to be addressed cannot be addressed by a small, isolated group alone and require collective action at the overall community level. For example, consider initiatives or programs to improve primary education, programs to keep teenagers from dropping out of school, programs to reduce the crime rate in a given area, attempts to attract new business relocations to a city or community, programs to develop an arts district or museum district in a city, attempts to attract a sports franchise, develop large parks or recreational projects such as zoos, or attempts to develop and open a new university. These kinds of efforts require the efforts and participation among many different individuals and groups with a collective scope of influence and capabilities greater than any individuals' influence, to identify a course of action, agree as to the scope and direction of the action, get funding, build community support, conduct voter preference campaigns, staff and administer the projects. Before such ambitious programs can begin, many people from various groups within the community need to have effective dialogues to decide whether, and how, to pursue a course of action. The meeting enhancement tools of the prior art, while somewhat effective in enhancing dialogue at meetings within a particular group, do not address the need to enhance dialogue across the community or group and to increase the influence of diverse groups of persons across and beyond their existing individual orbits of influence.

A need thus exists for a system, method and structured program to enhance the influence of individuals and groups within a community or organization and to expand their influence across the community or organization; and a need exists for a process to encourage frank dialogue between and among diverse groups of people who would otherwise not interact together and thereby expand the influence of the individuals beyond their normal orbits of influence. The present invention addresses these needs.

### SUMMARY OF THE INVENTION

A method, apparatus and system is described for use in increasing and enhancing the influence of individuals and groups. The apparatus includes various tools provided in the form of a kit, to enable a meeting facilitator to achieve a meeting of a diverse group of persons within an overall community, or within a corporate or non-profit organizational structure. The apparatus includes tools for identifying and soliciting diverse leaders within the community to act as sponsors for the meetings, tools for identifying and communicating possible topics to be discussed at the meeting, tools for communicating the meeting schedule and location and for encouraging attendance by the target members of the various diverse groups who are intended to benefit from the meeting. The apparatus described herein includes tools for use in enhancing the dialogue and influence at the event itself, including tools for allowing the members to self-organize in smaller groups, and game-like tools for use within the smaller groups to encourage the free exchange of frank dialogue between individuals and to increase their influence while addressing topics of their own choosing at the event; and tools and methods for allowing each smaller group to effectively autonomously conduct one or more dialogue sessions where frank viewpoints are exchanged and dialogue is encouraged and facilitated among all of the members, regardless of the individuals' social rank, age, economic or professional standing, or participants' racial or cultural diversity. Group, or Dialogue Circle, leaders kits are provided containing cards, objects and materials to enable self-selected group leaders to quickly learn how to facilitate and lead the dialogue session and to keep the exchanges open and to ensure fairness in speaking time and floor time for each member of the dialogue group.

Methods are provided to use the materials within the kit for enhancing influence to conduct one or more sessions. The methods include a method for selecting topics, a method for identifying and using sponsors, a method for communication and facilitation using a web-based interface or alternatively using bulletin boards, phone trees, recorded messages and other means to communicate about the event. Methods are provided to use the materials within the kit to facilitate the exchange of dialogue and enhance the influence at the particular session. These include methods which enable the attendees to self-organize, to propose topics they wish to have dialogue about, and to conduct the individual dialogue sessions in a manner designed to enhance and encourage each attendee to fully participate in the exchange.

Methods for conducting the individual dialogue sessions include the use of game-like techniques and tools, to facilitate proportional, time-shared dialogue and to encourage each individual to engage in the dialogue, even if the individual is by personality type passive or normally reticent in groups, as well as methods to encourage the dialogue group to value each individual's viewpoints, even if they lack particular experiences, social or economic standing.

Methods are further provided to use the tools within the toolkit to facilitate further meetings and extend the dialogue of participants beyond the initial meeting. Although it is expected some personal contact may be preferred by some of the members, as part of the discussion of the group, additional events may be planned. Alternatively, post-event communications may be provided so that the group, or members within the group, may self-organize and continue to enhance their influence after the initial event. Methods are provided such as website newsgroups, on-line chat rooms, and email lists are used to enable the group to continue the dialogue efficiently after the initial session. Other means such as electronic or manual bulletin boards or newsletters could be utilized.

Apparatus are provided in the form of kits to be used with the inventive system and methods. A dialogue circle leader's kit is provided which includes an Oracle ball, Oracle cards, leaders guide, dialogue goals cards, dialogue guidelines for the attendees, various banners and flags, and cards to receive insight and inspirations from the attendees. Additional apparatus are provided to be used to facilitate events that incorporate the system and methods of the invention, in the form of a facilitator's kit. This apparatus includes banners, portable walls for receiving removable topic placards, display posters or walls, a plurality of leadership kits, and may also incorporate software and other documents to facilitate planning and conducting an event which utilizes the system and methods of the invention.

### BRIEF DESCRIPTION OF THE DRAWINGS

FIG. 1 depicts a graphical representation of a set of spheres of influence in which an individual may have influence;

FIG. 2 depicts a graphical representation of the set of spheres of influence of FIG. 1 and overlying them, the graphical representation of the expanded influence an individual may gain by participating in the inventive event;

FIG. 3 depicts the graphical representation of a set of spheres of influence of FIG. 1 and overlying them, a graphical representation of the broadened influence possessed by multiple individuals who come together from different spheres of influence;

FIG. 4 depicts a flow chart of the event process of the invention;

FIG. 5 depicts a flow chart of the preparation process of the invention;

FIG. 6 depicts a flow chart of the set-up process of the invention;

FIG. 7 depicts a plan view of a typical event site where the inventive event system will be utilized;

FIG. 8 depicts a flow chart of the process of the invention during the event;

FIG. 9 depicts a dialogue leader's guide card of the invention;

FIG. 10 depicts a dialogue goal card of the invention;

FIG. 11 depicts a dialogue guide card of the invention;

FIG. 12A depicts a first set of Oracle cards of the invention;

FIG. 12B depicts a second set of Oracle cards of the invention; and

FIG. 13 depicts a timeline of a typical event and site utilizing the system of the invention.

FIG. 14 depicts a map that may be used by facilitators or participants as a guide to the flow of the process throughout the event.

FIG. 15 depicts an opening warm-up exercise that may be used to introduce the concepts of “Spheres of Influence” and “Orbits of Influence.”

Where common elements are used between drawing figures, common reference numerals are applied.

### DETAILED DESCRIPTION OF THE PREFERRED EMBODIMENTS

The invention is a system, method and apparatus for enhancing the influence of individuals and groups or institutions by creating exciting events where individuals experience a shared space, where they attend and autonomously conduct dynamic, frank dialogue sessions with diverse other individuals on topics they self-select or propose themselves. A facilitator or organizer can use the method, system and apparatus of the invention to plan, prepare, facilitate, conduct and complete the event. The event and the corresponding dialogue sessions are conducted in a coffeehouse, parlor or roundtable atmosphere. The dialogue sessions provided within the structure of the overall event incorporate the organizing principles of a parlor game and encourage networking, frank exchange of views and ideas, and participation by all of the attendees, even among individuals who are normally passive or reluctant to speak. Each event conducted using the inventions disclosed herein is unique as the attendees themselves determine the topics to be addressed for the dialogue sessions, as they themselves provide the dialogue, ideas and the views expressed and discussed, so that each event is a “one-of-a-kind” event. The attendees at the event will expand and enhance their spheres of influence through networking with, and exchanging views with, other individuals having different spheres of influence such that individual attendees may each benefit from the shared spheres of influence of the diverse group.

Applications for the system, method and apparatus of the invention are many. When a group or individual desires action or change within a community, many times the action or change desired is such that many other individuals need to be involved, because support for the action or change needs to be broad-based across diverse groups of people within a community. The invention provides a system for enhancing the influence and increasing the access to the individuals or groups to the broader group which is needed to build awareness and support for such community-wide or global actions or change. In a corporate environment, the invention may also be used to help the diverse groups within a corporate structure attain a better understanding of common concerns, expand their access and influence across division, regional or organizational boundaries, and build consensus for change such as identifying new products, new services, new markets or more fundamentally identifying and making other changes in the corporate plan or perhaps to build support for and begin a change in the corporate culture.

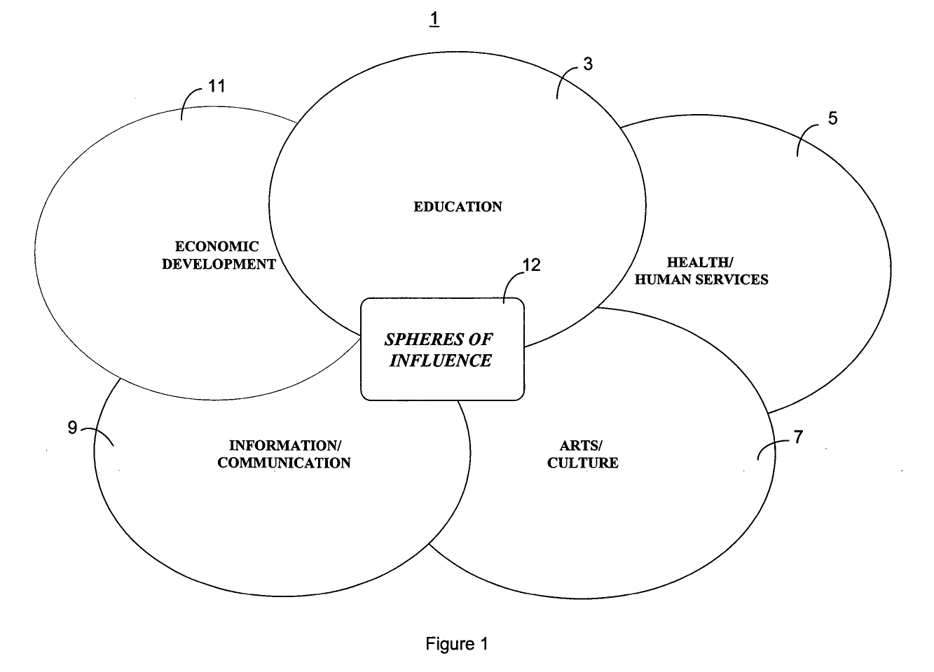

FIG. 1 is a graphical representation 1 of selected exemplary spheres of influence 2 in which an individual or group may have some contact with and possess influence. These are examples of spheres of influence which exist within a group or across a community; of course, many other examples may be selected. Sphere 3 is an education sphere of influence, for example an educator, a school administrator, governmental official, legislator, volunteer or parent may have influence in this sphere.

Similarly sphere 5 represents influence in health and human services areas. For example, medical professionals, academics, scientists, healthcare workers, again governmental and legislative professionals, agency employees, volunteers and interested members of the public will have influence in this sphere.

Sphere 7 represents influence in the areas of art/culture. Individuals having influence in these areas include artists such as visual artists as sculptors, painters, musical artists such as musicians, composers, other performers such as dancers, arts organizations administrators, museum directors, volunteers, and the interested public themselves, patrons of the arts, are individuals who have influence in this sphere. Sphere 9 represents influence in the areas of information/communication. Individuals having influence in these spheres include technologists in the information infrastructure fields such as telecommunications, Internet, wireless and other communication technologies, professionals in communications including broadcast media professionals such as television, radio, print media, as examples, again governmental agency professionals and employees, interested members of the public, and the like. Sphere 11 represents influence in the Economic Development area, individuals or groups having influence in sphere 11 could include, for example, elected officials having responsibility for urban or community planning, neighborhood groups and organizations, volunteer groups, chamber of commerce or business groups interested in developments in specific regions, cultural and spiritual groups having interest in development which creates opportunities for specific groups that are economically disadvantaged, administrators, governmental agencies and legislators with a specific interest in stimulating or regulating development, developers and real estate professionals, bankers or financiers and the like. Each sphere shown in FIG. 1 is an example only and other spheres, such as spirituality, finance, transportation, infrastructure, environmental, and many other examples may be chosen as areas where an individual or group exhibits influence.

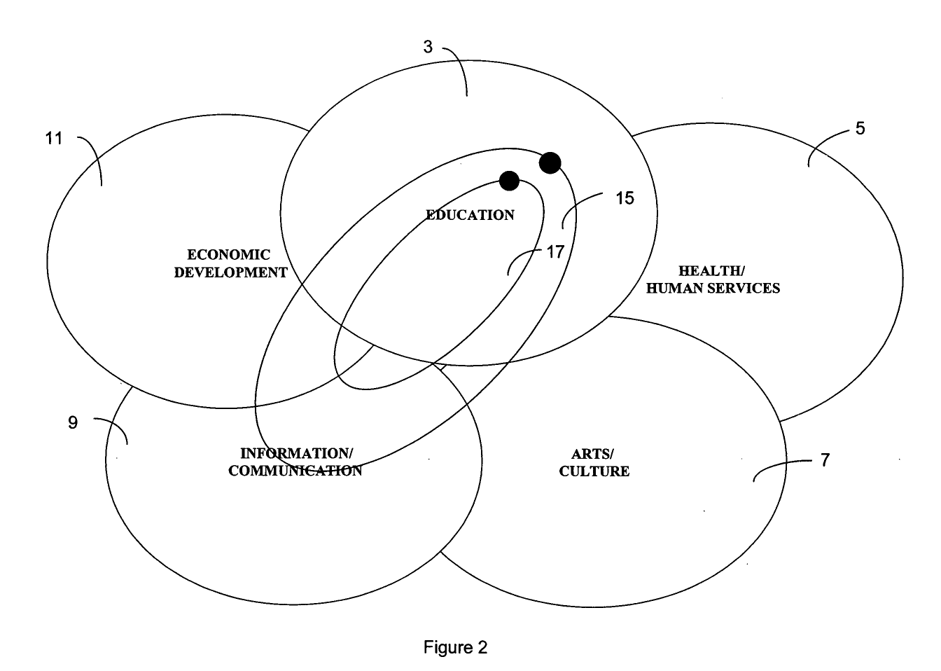

FIG. 2 represents the spheres of influence 3, 5, 7, 9 and 11 of FIG. 1 and the Orbits of Influence® (Orbits of Influence is a trademark registered to the inventors of this patent application) of particular individuals or groups are depicted as orbits 15 and 17. An Orbit of Influence® is manner of describing the various spheres of influence in which a particular individual, or group of individuals, have influence. For example, orbit 15 graphically represents the spheres of influence in which a particular individual or group has influence, for this example the individual has influence in sphere 3, education, sphere 7, arts and culture, sphere 9, information and communication, and in sphere 11, economic development. Note orbit 15 barely crosses into the arts and culture sphere 9 but primarily traverses the education sphere 3, thus indicating graphically that this individual or group has great influence in the education sphere of influence, but little influence in the arts and culture sphere, and none whatever in the health and human services sphere.

Consider orbit 17 of FIG. 2. The individual or group of individuals whose influence is represented graphically by the orbit 17 has influence in sphere 3, education, sphere 9, information and communication, sphere 11, economic development. Unlike the individual of orbit 15, this orbit does not traverse the sphere labeled “arts/culture”, so this individual or group does not have influence in that sphere. However, the other spheres are common to both orbits 15 and 17, that is, the individuals whose influence is represented by the two orbits share influence in the spheres 3, 9, and 11. Also, both orbits 15 and 17 primarily traverse sphere 3 and so both individuals are primarily influential in the education sphere 3. These individuals may be educators, parents, volunteers or professionals associated with education, for example.

These two individuals are likely to attend a meeting where they, and others with similar orbits, are in attendance. For example, if they are both educators they very well might attend a monthly meeting or a parent-teachers association meeting, etc. However as indicated by FIG. 2, even a lengthy dialogue exchange and networking session between these individuals cannot extend their collective spheres of influence. This is because the spheres of influence in which they are each active are not diverse from the other, their Orbits of Influence® are very similar, so while they may exchange viewpoints, they may not significantly increase their overall influence, nor may they significantly expand their influence by sharing influence only with each other.

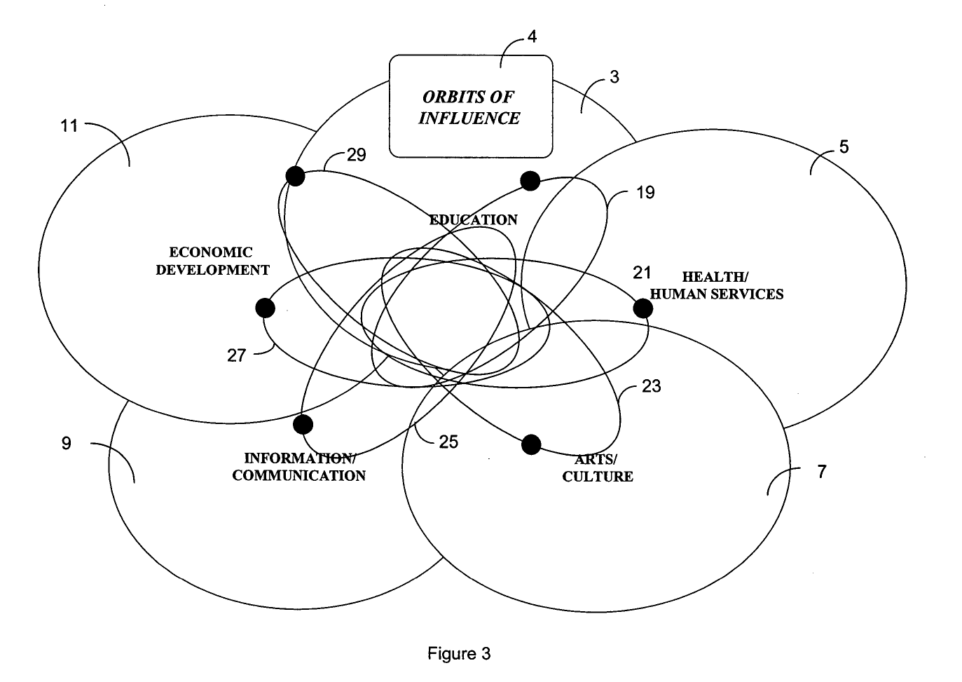

In contrast, consider the situation in FIG. 3. The orbits 19, 21, 23, 25 and 27 in FIG. 3 graphically depict the Orbits of Influence® where individuals or groups which are diverse from one another, and in which each has influence in spheres differentiated from one another. For example, the group or individual whose influence is represented by orbit 19 has influence in sphere 3, education, sphere 9, information and communication, and slight influence only in spheres 7 and 11. In contrast, the individual or group whose influence is represented by sphere 27 has influence in sphere 11, economic development, sphere 3, education, sphere 5, health and human services, and sphere 7, arts and culture. Each remaining orbit 21, 23, and 25 similarly traverses some spheres of influence which are common to some other orbits, and some spheres of influence which are differentiated from the other orbits. Thus it can be seen that in a dialogue where the diverse individuals exchange ideas and viewpoints, and in a networking situation where contact is made among these diverse individuals, the spheres of influence available to the group of individuals or groups represented by the collection of these various orbits is expanded as a result of the dialogue exchange and networking.

It is this end which the present invention of methods, including a programmed system and the apparatus required for conducting an event to enable and enhance the expansion of individual and group influence, advantageously attains.

The invention described herein provides methods, apparatus and a system for conducting an event where attendees will be drawn from a diverse group, attendees will self-select certain dialogue topics from within a “Universe of Ideas” that drive the focus for the event; attendees will engage in a large assembly session known as a Global Circle; attendees will the autonomously conduct dialogue sessions where they will exchange frank dialogue and viewpoints about the topics they have self-selected or proposed themselves; using a game-like approach, which incorporates an Oracle ball and Oracle cards that are also provided by the invention for use in expanding and enhancing participants' influence. The applicant has registered the service mark Orbits of Influence® to describe the types of services and events to be conducted using the methods, apparatus and system of the invention.

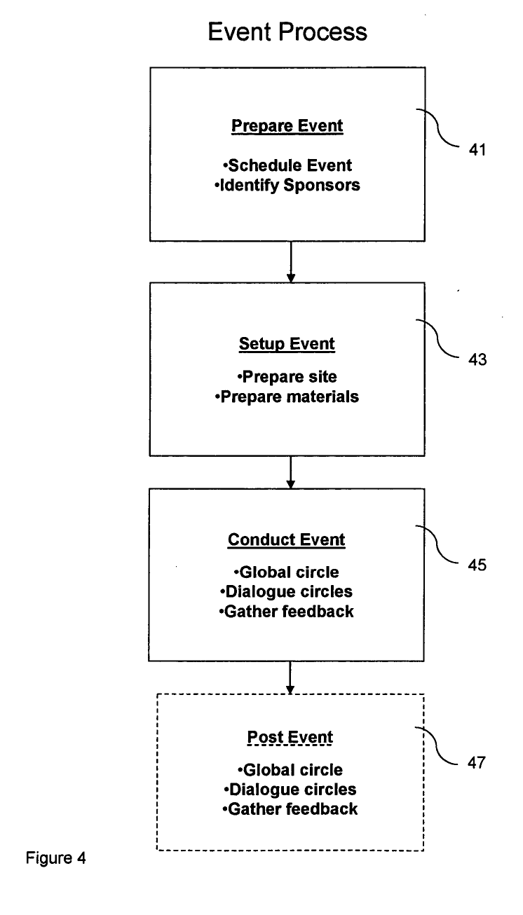

FIG. 4 depicts method steps, each of which is in itself a variety of smaller steps to be expanded in following figures, which are a first embodiment of the method steps of the invention. In FIG. 4, the steps of preparing, setting up and conducting an event utilizing the methods and apparatus of the present invention are depicted. Step 41 is a Prepare Event step, in which one or more event facilitators will plan, define, schedule, announce, invite participants to, and organize an influence-expanding event, incorporating the methods and apparatus of the invention. In the Set Up Event step 43, the facilitator and a variety of volunteers or employees (who may or may not be event participants) will set up the event space, in a manner to be further described below, in order to enhance the experience and maximize the impact of the event on the influence of the participants. In step 45, the facilitator and the volunteers or employees will conduct or moderate the event. The event is conducted utilizing the methods of the invention so as to enable the attendees to participate in a large group session known as the Global Circle, to self-select or propose the topics around which they wish to exchange dialogue. The attendees will then participate in self-selecting the dialogue groups, which may be referred to as Dialogue Circles or Orbits, whose topics are of most interest to them; some of the participants will act as self-designated group leaders. Facilitators will assist with the attendees participation in the large group and small group dialogue sessions and networking, and collect and display the insights and next steps the attendees identify as important or desired to the group. In optional step 47, the facilitator will conduct post-event steps to enable the attendees to continue to exchange dialogue, plan future events, and network with other attendees in order to continue the process of expanding the influence of the participants that begins during the actual event.

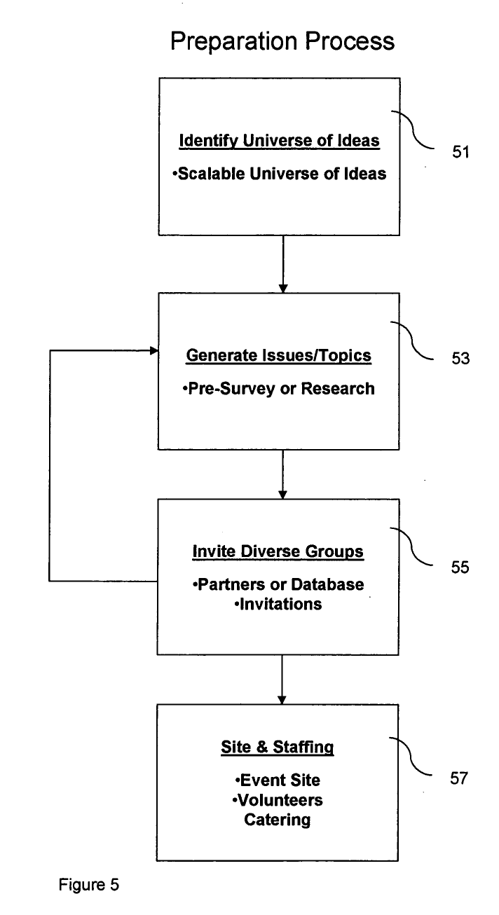

FIG. 5 depicts the steps executed by the facilitator in preparation for an event using the system of the invention. In step 51 the process begins by identifying the scope of the event as the “Universe of Ideas” that will be used to drive the particular event. The Universe of Ideas is a scalable group of ideas which defines the scope of available dialogue topics and/or issues which will be used for a specific event or be directed at a group of target attendees for a future event. As many events will be community-based, the Universe of Ideas that is used, for example, in a community-based event in a large urban center may be quite broad. Alternatively, for a internal, corporate-based event, the sponsor or leader who is requesting the event may work with the facilitator to limit the scope of the Universe of Ideas; for example, the Universe of Ideas may be limited to “Customer Satisfaction” and the available dialogue topics are then those topics or issues which can be said to reside within that Universe of Ideas, so that perhaps “charitable giving,” while an interesting topic, is not available for dialogue at a particular corporate event. The Universe of Ideas gives the facilitator a framework within which to focus the content for the event and also, by announcing the Universe of Ideas and proposed topics in the early communications about the event, assures that the attendees are already thinking of dialogue topics and ideas they may wish to exchange, which relate to the overall focus or goal for a particular event. However, proposed topics will be evaluated to ensure they are within the overall Universe of Ideas, as this drives the scope of the topics at the event.

Once the facilitator and preferably the leaders of a particular group or other sponsors for an event have agreed on and expressed the Universe of Ideas for an event, the facilitator moves to step 53, “generate issues/topics.” This method step involves using either arbitrary or more rigorous methods for selecting proposed dialogue topics, remembering that the topics must fall within the scope of the designated Universe of Ideas. Different approaches to the method of generating topics may be used; for example, a limited survey may be sent to certain leaders or sponsors of an event and they may either respond directly with dialogue topics they wish to be available at the event, or, a survey may be devised to identify particular areas of concern or interest, and then dialogue topics could be written by the facilitator in response to the survey. Alternatively, a wider survey could be sent to the proposed attendee body again asking for direct input as to certain topics the attendees would like to discuss, or again by devising a survey intended to identify the concerns and interests of the target attendees and then using the results of such a survey to devise appropriate dialogue topics. As another alternative approach, the event facilitator may conduct research into current events, pending legislation, news periodicals or industry journals to identify topics that appear to be of high interest to the attendee audience and use those as a starting set of dialogue topics. The facilitator may have topics which were used at previous events for a similar community or group, and these may be sufficient for a particular event without the need for surveys or research. The method and system of the invention provide additional flexibility in that, as the attendees arrive at the event, they may self-select a pre-selected topic from the Universe of Ideas, or propose a new topic, or potentially modify one of the pre-selected topics to change the scope or direction that it takes. Thus the method and system of the invention provide for a self-selection process so that the attendees at an event will always be able to engage in a dialogue on a topic of interest or concern to them, even though some of the topics are also proposed in advance by the facilitator or the leader or sponsor requesting the event.

In Step 55 the facilitator will proceed to send invitations to diverse groups. As previously shown in FIG. 3, the diversity of the group which engages in the exchange of dialogue and the networking at the event directly impacts the ability of the event to expand the influence of the attendees both individually and collectively, so it is important to ensure the invitation process works to expand the diversity of the potential attendees. In order to accomplish this need, the facilitator may use many different approaches. The leaders or sponsor of an event may have a mailing list, membership list or database for a particular group. This may be expanded by purchasing or requesting mailing or membership lists from other groups which are active in the community. The facilitator may have a list of attendees who have attended previous events, and for community events the facilitator may include those persons in the invitations. The facilitator may have a membership; that is, for community events, a model contemplated by an embodiment of the invention herein is a subscription or membership model whereby the attendee is guaranteed to be notified of upcoming similar events and may, by prepaying or by purchasing a membership, get early notice or preferred pricing in the form of a discount on the participation fee or materials fees associated with the events. The facilitator may encourage other diverse groups such as universities, churches, schools or industry groups such as medical and bar associations to make their membership aware of the event. Further, the facilitator may use a web-based communication model where a web site is maintained listing events for a specific city or region, and optionally allowing attendees to register at the website. Alternatives include using bulletin boards at churches, schools and government offices, billboards, running radio and TV spots, newspaper and magazine and the like to publicize the event to the potential attendee audience.

For corporate events, a list of desired attendees may be provided. Because the enhanced influence of the invention is best achieved with a diverse group of attendees, the facilitator may work with the sponsor of a corporate event to attempt to broaden the proposed attendee list to include persons of various ranks and from various functional groups within the corporate organization. For example employees from departments such as human resources, law, finance, compliance, quality control, production, transportation, facilities, design, engineering, management are potential organizations within the corporate structure who may not have common spheres of influence, and so provide a diverse group able to enjoy the benefits of the invention, that is to expand their influence. Industry experts or academics could be added to a corporate event to provide some outside influence and views, for example a venture capitalist or investment analyst may provide some diverse views which would benefit an otherwise “in-house” event. Leaders in government or non-profit endeavors may also be invited to corporate events, particularly those concerned with developing or understanding a corporate culture, or addressing the corporation's role in the community or global economy.

Further, some corporate events may be designed to that attendance is mandatory or strongly encouraged, this is acceptable although because the attendees generally self-select topics for dialogue and the process during the event is basically run by the attendees themselves, better results may be expected where the attendees are given an opportunity to attend and then independently choose to do so.

Step 55 includes a feedback path to the step 53, “generate issues/topics.” As the attendees accept their invitations and return registration materials to the facilitator, they are optionally given the opportunity to identify additional topics for dialogue not listed in the Universe of Ideas presented to them in the event invitation. Accordingly it is desirable to accept input from the registrants and incorporate popular or repeated suggestions for topics into the Universe of Ideas, thereby assuring that the attendees will have the opportunity to conduct dialogue and exchange ideas in dialogue sessions directed to topics of greatest interest to them. The invention thereby provides a dynamic and flexible method for identifying the topics within the Universe of Ideas so that the event can provide the greatest impact and maximum benefit to the attendees.

Step 57 is the Site and Staffing step in the preparation process. The facilitator needs to assure that the physical space provided for the event will also enhance the experience the attendees have during the event. To that end, the facilitator needs to have a target attendee number in mind. Depending on the number of dialogue circles that will be used, and, the amount of time available, the facilitator needs to be sure the physical space is roomy enough to provide the attendees the opportunity to move about in the larger group sessions, yet still see and hear various exhibits and speakers. The site needs to have good lighting, adequate ventilation, access for the disabled if needed, bathroom space that is convenient, secure and adequate, and parking that is also secure and adequate. It has been determined that to enhance the experience and enable the attendees to fully focus on the dialogue and group sessions without distraction, it is generally desirable to serve light refreshments before the event. The type and amount of food can be varied depending on the time of day and the preferences of the community or corporate audience, but preferably a period of time will be provided before the event which will enable the attendees to satisfy their hunger while simultaneously networking and observing various exhibits and materials designed to enhance their experience. If the event is an evening event, which is often preferred for community events to enhance the ability of a diverse group of people to attend, a light dinner or various appetizers may be served in a manner such that the attendees can enjoy it while still moving about the space and meeting various other attendees, also beverages should be available. The intent is to enable the attendees to focus on the event and not be concerned with eating before they arrive, or experience hunger or thirst during the event, so that they are comfortable and relaxed and may focus their attention on the dialogue and the exchange of ideas.

If an event is scheduled at a space where food is not permitted or available, then a lunch break or dinner break or other method of allowing the attendees to eat during the event is recommended, but this is not believed to be optimal, as it breaks the group up and distracts the attention of the attendees. In some instances it may possible to get the food or catering donated by a restaurant or food supplier. The facilitator can offer sponsors such as individuals and businesses the opportunity to provide the food at an event and provide appropriate recognition thanking them for the contribution such as display areas for their logo or business information at the event, listing their name prominently in the materials packets distributed at the event, thanking them formally during the event, and providing name recognition in and around the catering table.

Site selection is important to the appeal and success of the event; however, many different possible sites may be considered. Many hotels and conference centers have spaces available that are well suited for use with the system and method of the invention. University lecture halls, church fellowship halls, and other large meeting rooms such as government council chambers and the like are possible sites. During the event, the group will assemble as a single large group for certain aspects of the program, and then gather in smaller dialogue circles during the larger event for the frank exchange of dialogue. Accordingly it is important that the site be amenable to both types of gathering, by providing sufficient space for the entire group to be assembled, loudspeaker or other audio facilities to enable the large group to hear a speaker or announcement, and also, smaller tables or areas that will become the salons or parlors for the smaller dialogue groups; these should preferably be arranged so that while they are simultaneously involved in the smaller groups, attendees can focus on their own particular dialogue sessions without being interrupted or distracted by noise or laughter from adjacent groups.

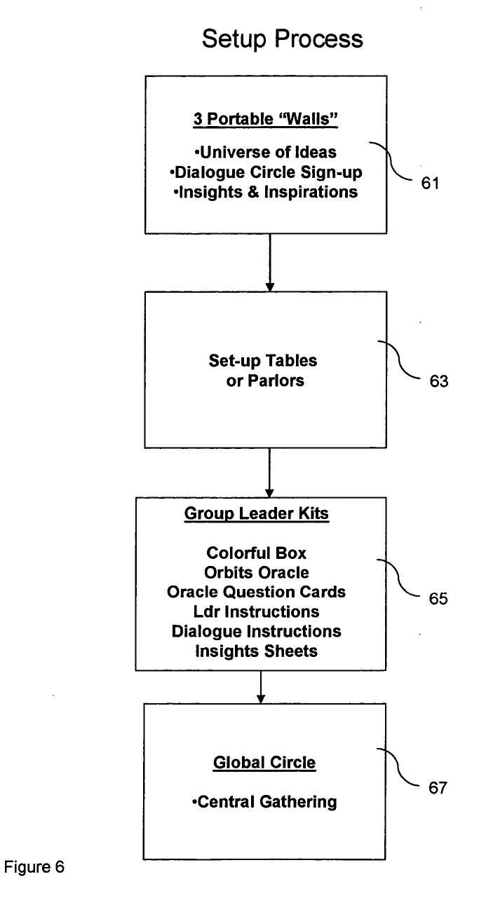

FIG. 6 is a flowchart depicting the steps to be executed during the set-up process for the event. The day of the event, or perhaps the day before, if the site is available, the facilitator should arrive early enough and with enough volunteers or paid staff members to properly prepare the site. Because the environment of the site will be used to inspire the attendees, and to reinforce the methods they are to follow during the event to maximize the beneficial enhancement of the individuals' spheres of influence, it is important to ready the site well in advance of the attendees' arrival. The steps of FIG. 6 are utilized, in no particular order, to ready the site for the event.

Step 61 is to setup several “Walls” or display areas which will be widely visible to the attendees during the event. Preferably there are at least three walls in the larger assembly area where attendees will initially gather, enjoy their refreshments, and network by introducing themselves, in an informal setting, to other attendees.

The first wall is the “Universe of Ideas” wall. The Universe of Ideas wall may preferably include a poster or banner titled “UNIVERSE OF IDEAS” and, before the attendees arrive, will include the pre-selected topics/issues for dialogue which are printed on removable placards or large removable adhesive paper pads or other forms of movable signs. These signs are available for the attendees to pick up and move, as will be explained below.

A second display of wall is the Dialogue Circle sign-up wall. Before the event, this wall will be labeled with a highly visible sign such as DIALOGUE CIRCLE SIGN-UP or ORBITS SIGN-UP and will be placed behind a sign-up table, which will preferably be staffed during certain portions of the event by a facilitator or volunteer. At the beginning of the event, typically nothing else is displayed on this wall.

An optional third portable display wall is the INSIGHTS & INSPIRATIONS wall. This wall is placed at the site in a manner so that it is highly visible and placed so that the attendees can walk up to it and visually examine it. Preferably, various inspirational materials may be displayed at the beginning of the event so as to reinforce the method of the invention, that is, to communicate to the attendees their role as active participants, global thinkers and community leaders and to inspire them to freely express their ideas, open their minds to diverse views, make new connections and network, and to share and thereby expand their spheres of influence during the event, and encourage them to continue on with these activities afterwards. Later on in the event, participants may express their own insights and inspirations which develop during the dialogue sessions by posting these ideas in written form onto the “Insights” display wall using additional removable placards, removable adhesive notes or other portable media signs so that the larger group may examine and perceive visually these ideas and insights, as well as add their own. These ideas and insights may also be shared with a broader audience by posting them in an identifiable and accessible location in a public forum, such as on a bulletin board, or online, as well as through any number of communications vehicles, such as newsletters, emails, listservs, and the like.

Step 63 is to set up the circles, or parlor areas, for the small group dialogue sessions. After an initial larger group gathering, the attendees will be conducting small group sessions of dialogue using the methods of the invention, which are described further below. Accordingly the site needs to incorporate areas for these small group dialogue sessions. Typically these areas will be round tables or round seating circles with 5-7 seats each, or more or less depending on the particular event. The small group seating circles need to be spaced so that during the small group dialogue sessions, the smaller groups can hear the dialogue at their own group while simultaneous sessions are going on around them, without getting distracted and without distracting other groups. Alternatively, small meeting rooms adjacent the larger room could be used as meeting “salons” or “parlors” if the site has facilities of that manner.

Step 65 shows the set up of the group or dialogue circle leader kits. An attendee group leader will be identified as described later for each of the dialogue sessions. Each group leader will receive, during the initial stages of the event, a set of materials. These kits, therefore, need to be set up prior to the event. These group leader kits will be described in full detail below, but include materials which reinforce the concept of the Orbits of Influence®. In one exemplary embodiment, the kits may include a ball or object labeled the Oracle ball, Oracle question cards or worksheets, a card or worksheet with directions for the group leader, instructions for the dialogue session which the leader is to share with the group at the outset of the dialogue session, a timer or hourglass device, various sheets of paper and pens, pencils, markers, placards for the Insights wall, and any other material a particular facilitator might find helpful to include such as a clipboard, whiteboard, flip charts and the like. A group leader kit is to be provided for each roundtable or parlor area where a dialogue group is to meet. Preferably the group leader kit is either provided at the table so that when the group assembles, it is already in the seating circle or parlor space, or the group leader kits are kept at a table within the larger assembly area known as the “leaders” table” . In a case where such a table is available, there may be a facilitator or volunteer assigned to that table to review the group leaders' kit with those attendees that self-designate as group leaders during the event as described below.

In addition to setting up the smaller group dialogue circles or tables, the setup process includes step 67, setting up the larger area known as the “Global Circle.” As will be seen below, this space may simply be the overall assembly space which includes the seating circles, or it might be a large gathering space away from the seating circles. In any event it includes the elements of the Universe of Ideas wall, the Dialogue Circles wall, the catering stations and beverage service stations if they are provided, the Insights and Inspirations wall, and various displays and exhibits describing the Orbits of Influence concepts, reminding attendees about the process to use during the dialogue sessions, inspirational sayings and thoughts from literature and culture such as famous quotations, sayings, scripture or philosophy from various cultures, and the like.

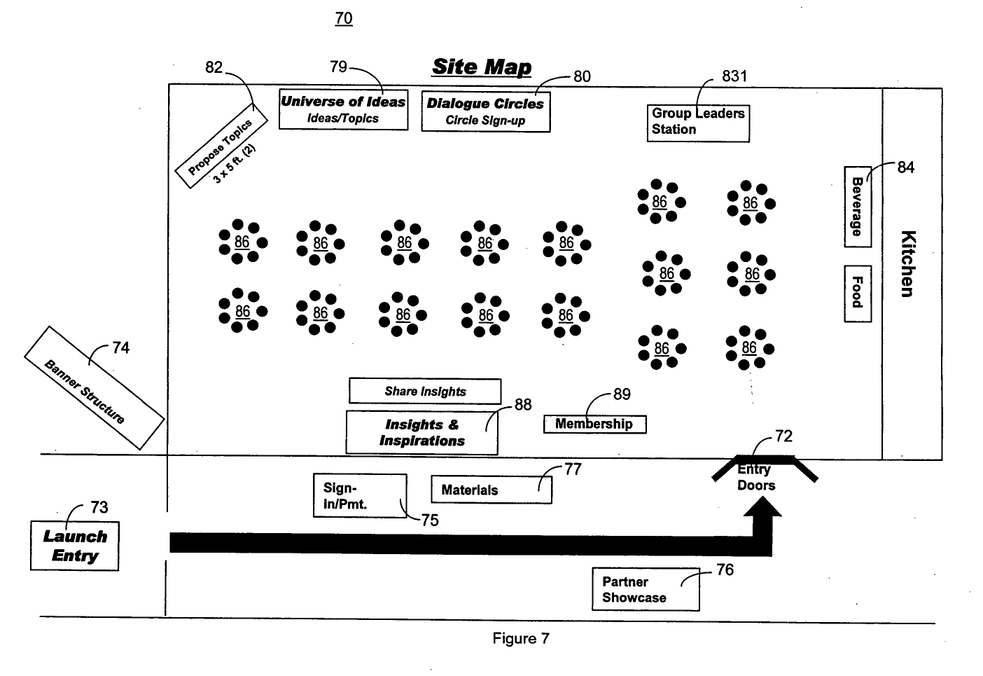

FIG. 7 depicts, in an overhead view, a typical event site 70 for use with the methods and apparatus of the invention. In FIG. 7, attendees will arrive at the outer entry area 73 labeled Launch Entry, and preferably the theme of Orbits of Influence® will be reinforced with posters, banners, signage, visual or audio display areas 74 at the Launch Entry doorway so the attendees will begin to comprehend the purpose and the methods to be used during the event. After passing the Launch Entry, attendees will encounter the “Sign In” table 75, where they will sign in and make a payment if one is still owed, and then proceed to the “Materials” table 77 where they will receive certain materials to review. The materials will typically include a sheet of instructions or a card detailing for the attendee the methods to be practiced by the attendees during the event as described further below, a map of the facility may be attached indicating the location of bathrooms, telephones and other facilities, and in order to enable and enhance the opportunity to network and expand influence during and after the event, the attendees will receive nametags to wear so as to make introductions to the other attendees easier.

An optional feature which the facilitator may use to increase funding or donations to the event, and which may increase the interest and excitement about the event, is the Partner Showcase, 76. At the partner showcase 76, various business organizations, community organizations and individuals who have agreed to sponsor the event, provided membership lists, publicity, endorsements or encouraged attendance to the event, provided monetary or in kind donations such as refreshments, materials, entertainment or the like may be given the opportunity to display business or agency information, and thereby receive recognition by the attendees for their generosity. In planning the event and seeking support both financial and in-kind, the facilitator may offer name recognition of various sorts and levels, and the size and placement of the name recognition may be proportional to the amount of support provided.

The attendees may continue towards the site passing the partner showcase 76, if one is used, and entering the site through the entry doors 72. When the attendees arrive, the preparation and set-up processes described above are complete, and so the site has the features described above in place. The attendees can see the walls described above, here the Universe of Ideas wall 79 will contain those pre-selected dialogue topics which have been developed, displayed on moveable placards, perhaps using cloth hook type fasteners, or removable adhesive notepad sheets or similar moveable cards. Optionally, adjacent the Universe of Ideas wall is an area for a scribe 80, who can create additional topic cards at the request of the attendees. A volunteer or facilitator may be stationed at the scribe table to perform this function.

As described above, the Dialogue Circles 80 wall is near the Universe of Ideas wall 79 and the attendees can see and access this area, as well. A volunteer or facilitator employee may be stationed at a table located in front of this wall. In another area, preferably is a table 831 referred to as the “leaders' station” where the attendees will go if they are, through the process described below, determined to be a group leader for a dialogue session. At the “leaders' station” the attendees receive their group leaders' kits and preferably another volunteer is situated at this table to train the group leaders about how to conduct the dialogue sessions using the various materials in the group leaders' kits, these methods are also described in more detail below.

Wall 88 is the “Insights & Inspirations” wall, which is an optional but preferred feature of the system of the invention, during the smaller dialogue sessions the attendees are encouraged to record their particular “insights” on removable placards which may be attached by cloth hook tape, or use removable adhesive notepads, or other removable signs or placards to the Insights wall during the event, as will be further explained below.

The site will preferably include a catering station 84, where the attendees can now obtain their refreshments while they walk about the site observing the various elements and interacting with one another prior to the beginning of the Orbits of Influence® event itself. Seating circles 86 are shown in the site, in this example there are 16 circles each accommodating 7 persons which provides a possible attendance of 112 persons. Many more attendees or far fewer can be accommodated for a particular event using the system and methods and the apparatus of the invention, the invention provides a flexible and scalable system for conducting the event. The site should be arranged to accommodate all of the attendees during part of the event, as will be further described below, and sight lines and sound systems provided to accommodate the whole group, at later times in the event the attendees will be gathered in the smaller dialogue circles and so the site must also accommodate that arrangement comfortably.

There should be a limit to the number of attendees at a given seating circle, so that all attendees can and will participate in the dialogue sessions, and so that, if more attendees are to be accommodated, a like increase in the number of seating circles must be made to keep the dialogue sessions at a reasonable number of attendees. Note that there is not a problem if several dialogue circle groups choose to dialogue on the same topic; that eventuality is anticipated, and handled within the inventive process, as there is a strong likelihood that one particular topic may be of a strong interest to more than one group of attendees or circles at a particular event. Recent events such as war or terrorist acts, crime or other events in the community may be so profound as to inspire a strong desire in many attendees to participate in a dialogue about them, and the methods of the invention flexibly accommodate that interest. Alternatively, and perhaps more typically, the smaller dialogue groups will choose differing topics for the dialogue sessions.

Table 89 in site 70 is an optional membership table. One feature of the system and method of the invention is that for community events, some attendees may desire to be notified about and attend future events. A membership or subscriber model of participation may be offered where an attendee can reserve an attendee's spot at a series of events over a given time frame, typically an annual subscription or membership, and by prepaying for the events, may be offered a discount or other tokens of recognition such as coffee mugs, T-shirts and the like to recognize that persons' status as a member of the Orbits of Influence for that community. This table enables those attendees with the highest level of interest to maintain the connection to the facilitator and the other like-minded attendees, and provides a core group of attendees for receiving invitations to future events.

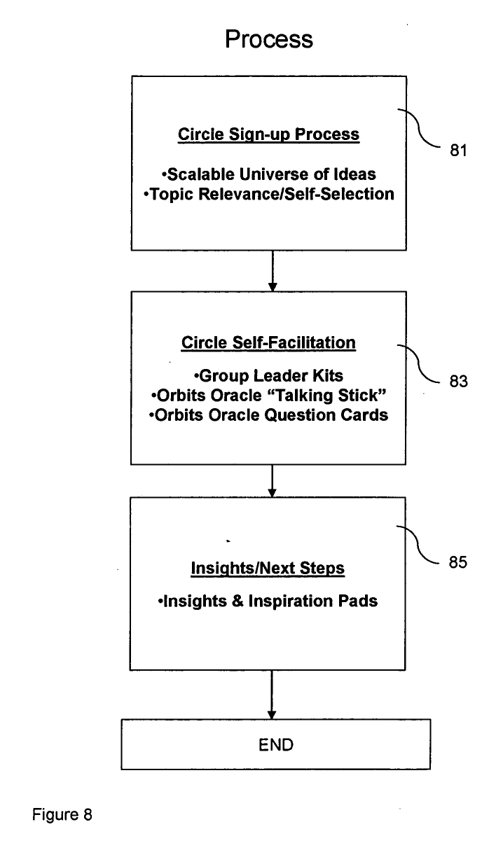

Having described the preparation process, the set up process and having detailed the physical features of the site for the event, we will now describe the advantageous processes that occur during the event itself with reference to the process steps of FIG. 8 and with reference to the physical diagram of the site as described above in FIG. 7. The sequence of the process to follow is recommended as a model and a guideline for event facilitators, although the process is flexible enough to allow adjustments in sequence of steps to accommodate specific needs, timing, and interests of a given event, based on the event director's expertise in group dynamics. As the attendees arrive at the site, they are first registered and receive nametags and a few items to assist them during the event such as an explanatory handout or card. Participants may also be advised, or receive reminder materials, that state that all comments shared during the event and dialogue circles will be held by all participants as confidential, unless specific permission to share comments is given by the individual who shared them. The attendees then enter the hall. If desired, the event director may provide a brief orientation or overview of the Orbits of Influence process at the opening of the event; participants new to the process may join this overview, while other experienced participants may choose to freely network and enjoy refreshments during the opening moments, as participants arrive at the event. Event directors and facilitators also have the option of offering more in-depth training in dialogue and related methods, in conjunction with Orbits of Influence events, this training can be very conveniently offered prior to the beginning of the Orbits event to the attendees and/or others interested in dialogue and related methods.

At step 81, the process of self-selecting various topics for dialogue begins. Prior to the structured part of the event, the attendees are directed to visit the Universe of Ideas wall where they can examine the various topics available for dialogue during the event.

Moving now to Step 83, if an attendee finds a topic at the Universe of Ideas wall that for which they desire to become the Group Leader they self-select as a group leader for the topic by removing the placard (or, alternatively, asking a volunteer assigned to this task to remove the placard) and carry it to the Dialogue Circle Sign-up table. At that table, the placard will be placed on the Dialogue Circle wall and the Group Leader's name will be added beneath the placard. Alternatively, if an attendee wants to dialogue on a particular topic, but not lead the group, the group leader can be selected later from among the attendees that choose that topic, or if no one of those persons wants the role, in that rare case, a volunteer may act as the group leader.

A group leader, after selecting their topic, is directed to the leaders' table where they receive the group leader's kit. In one form, the group leader's kit is a color-coded, colorful box or bin, although other forms may be used which contains some or all of the following items:
1. A Topic Sign, preferably color-coded, for indicating to the attendees which topic a particular group in session is addressing,
2. A Group Number to aid the attendees in locating a particular group.
3. A Circle Sign-Up sheet which is used at the Dialogue Circle table to sign up for a dialogue group and which the group leader can use to identify her group members.
4. Evaluation sheets which are to be distributed to the group members.
5. A Group Leader Guide which is further explained below
6. Oracle Ball and Oracle Cards, also explained further below.
7. Placards or removable adhesive notepads for recoding the groups Insights and Inspirations, these are optionally displayed on the Insights & Inspirations wall after the dialogue session.
8. Other optional materials such as pens, paper, pads, notepads, flipcharts and the like.

The attendees continue to arrive and can now visually perceive that some topics have been chosen for dialogue by the simple method of visually noting that those topic placards are now displayed on the Dialogue Circle wall, having been moved from the Universe of Ideas wall. The attendees now may choose an existing Dialogue Circle by proceeding to sign up for a circle at that table, or in the alternative, they can visually perceive the remaining pre-selected topics that have not been selected because those topic placards remain on the Universe of Ideas wall. Further, the attendees may, if they desire, add a new topic by going to the scribe table adjacent the Universe of Ideas wall and requesting a new placard be created by the scribe.

The attendees are each directed to sign up for a first dialogue session as either a group leader or a participant, so it is expected that as the attendees continue to arrive, each will eventually proceed to the Dialogue Circle wall and sign up for one of the dialogue sessions. Preferably, encouraging announcements are made as the start time for the structured part of the Orbits event nears. Volunteers can optionally cross the attendees names off a list so as to be able to individually call out to any attendees who, at the end of the preliminary sign up time, have failed to sign up for a dialogue session.

If the number of attendees wishing to join a Dialogue Circle on a given topic exceeds the number of positions available at the seating area or roundtable or in a parlor for that topic, a couple of alternative solutions are available to the facilitator. First, in a preferred embodiment event of the invention, at least two different dialogue session times are provided so that each attendee will participate in at least two dialogue sessions, the attendees can return to the desired Dialogue Circle topic during the second session, if they so choose. Further, if a substantial number of attendees indicate they wish to participate in the same Dialogue Circle, an additional placard is created and a second group leader is self-selected, and the result is more than one dialogue circle will address the same topic, enabling more attendees to participate in that particular dialogue.

The attendees eventually will have all signed up for the first dialogue session at the particular event. At this point, the Global Circle, or large assembly of the attendees, is held. During the Global Circle, various instructions and announcements are made. The facilitator may introduce certain persons who sponsored or commissioned the event. The facilitator or a community leader or other speaker may then explain the Orbits of Influence® concept to the attendees, perhaps referring to graphical materials which may appear, for example, generally as depicted in FIG. 3. The moderator or facilitator may then introduce the attendees who have self-selected to be Group, or Dialogue Circle, Leaders, and if it is deemed necessary, direct the attendees as to where the various dialogue circles will be held, especially in a setting where, for example, different “parlor” rooms are used rather than the “seating circles” in the overall site room.

If appropriate, the facilitator or moderator may provide an inspiration in the form of a quotation or message, including for some events where it is most appropriate, an invocation from a pastor or rabbi, or a group prayer may be led. Typically, the first Global Circle portion of the event may require 5-15 minutes, or more or less if additional speaking is desired. For example, at a corporate event the CEO or another leader of a corporation may desire to deliver a message encouraging the attendees to fully participate and benefit from the event; at a community event an invited inspirational speaker may address the audience to increase the excitement and importance of the event to the attendees.

The attendees are then directed to convene their Dialogue Circles, sometimes referred to as dialogue session or Orbits. Preferably the seating circles or roundtables or parlors are labeled with distinctive colors which can match colors used for the topic placards on the Dialogue Circles wall, so as to assist the attendees in visually locating their group. Additionally, when the attendees sign up for a Dialogue Topic, they may be handed a token or otherwise given a group number. Group leaders may be provided, in the group leader's kit, a large colored sign or flag to display and thereby assist the attendees in locating their group.

The event process now transitions to the dialogue sessions. The group leaders have been provided, in their group leader's kits, a variety of materials. These include an Oracle ball or object, a Dialogue Circle leaders guide, Oracle cards, preferably a timekeeping device such as a timer, hourglass or stopwatch, a Dialogue Goal and Dialogue Guidelines handout or card, evaluation sheets, and Inspirations recording materials such as paper, placards, whiteboards, adhesive notepads, or the like. The group leaders are provided with instructions called Leader Dialogue Circle Guides which may include the following stepwise process for conducting the dialogue session, although other formats are also possible and within the scope of the invention:
1. Check out your group leaders materials kit from the Leaders' Station table
2. Locate your group number and Dialogue Circle sign.
3. Convene your Circle by going to your seating circle and holding up your Dialogue Circle sign.
4. After your group members arrive, announce your dialogue topic and introduce the group members.
5. Introduce the Dialogue Goals and Guidelines.
6. Introduce the Oracle Ball and Oracle Cards.
7. Begin the initial Dialogue Round. All members will speak in an approximately equal time, round robin fashion or using some other fair access method. The initial round will be followed by voluntary additional discussion with time limited individual speaking times to continue the dialogue exchange until the session time ends.
8. Distribute evaluation sheets to each group member and make the Insights pad or placards available.
9. Conduct the Dialogue session, and at the end of the allotted time, encourage the group to submit their insights and inspirations for display on the Insights and Inspirations wall within the site for the next Global Circle.
10. Collect the Group Leaders' kit materials and place them back into the Group Leaders kit, as they will be used again in a subsequent dialogue session.

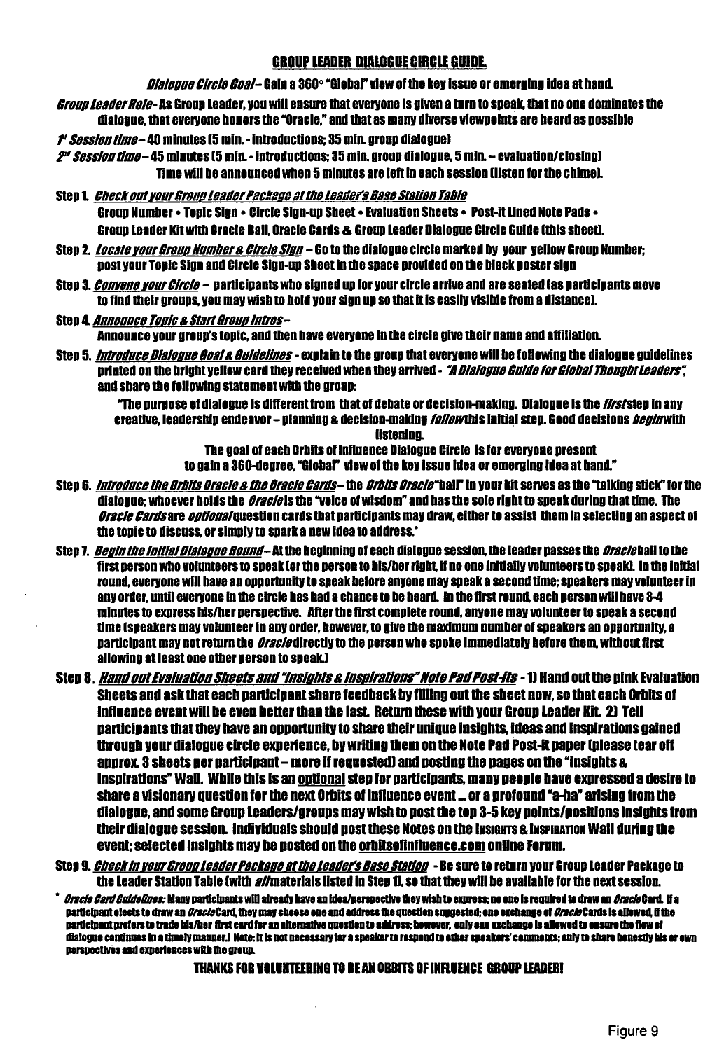

The Leaders Guide may be provided for example as shown in FIG. 9.

The time allotted for the first dialogue session is variable and may be determined by the facilitator and the sponsors based on the total time allocated for the event, however it may preferably be 30-45 minutes. As the first 3 steps of the Dialogue sessions are described above, the remaining steps are described here. Step 4 is for the group leader to read the dialogue topic to the group, again, and introduce each of the individuals at the seating circle or roundtable or parlor to the group members.

Step 5 is to introduce the Dialogue Circle Goals and Guidelines. These are provided in the group leaders kits in the form of cards or handouts for each attendee to refer to during the session and preferably were distributed to the attendees in the form of a card or handout at registration. The goals and guidelines are designed to maximize the exchange of viewpoints and to enhance the influence of the attendees by enabling a full exchange.

To that end, the Goals are, for example, to:
b 1. Gain a 360 degree, Global view of Key Issues and Emerging Ideas
2. On an Individual Level:
   Expand your Orbits of Influence—Personal, Social, Work and World
3. On a Collective Level:
   Explore Connections and Broader Possibilities across Multiple Spheres of Influence:
      example—Spheres are Economic Development, Education, Health and Human Services, Arts and Culture, Information and Communication.

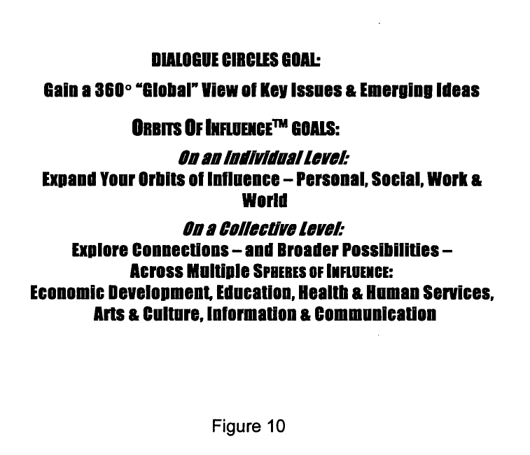

The Goals may be provided in card form as shown in FIG. 10.

Step 6 is to introduce the Guidelines for the Dialogue. The guidelines are also preferably provided in card or handout form and may be generally stated, without attaching any particular significance to the order or form, as:
1. Listen to Understand. Listen respectfully, openly, generously and intently;
2. Express Your True Voice. Share your experiences, your perspectives, your passions, your possibilities
3. Open your Mind. Especially to perspectives that are different, even divergent, from your own
4. Connect with Others. Seek to recognize each viewpoint as a valid and valuable fragment essential to seeing the greater, collective whole
5. Challenge Yourself. To search for the strengths and truths in others positions . . . to reflect on your own assumptions and values . . . to move beyond your current comfort zone
6. Dare to be Bold. In exploring new mindspace . . . true leadership occurs in uncharted territory where no one has yet laid down a path
7. Expand your Realm of Possibility—stretch beyond the current view of what is . . . learn to navigate in the creative real of What Can Be

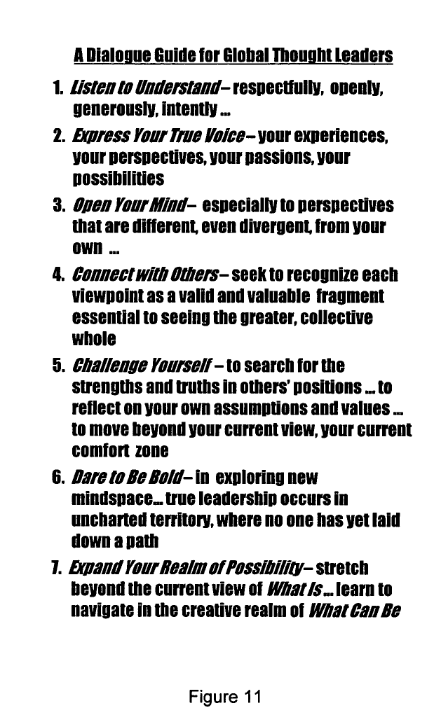

The Guidelines may be provided in card or handout form as shown in FIG. 11.

Step 6 of the Dialogue process is to introduce the Oracle Ball and Oracle Cards. The Oracle ball is an object, generally any object will work that may be handed around the group and which is easily distinguishable and held without discomfort, but an exemplary object is a ball. The ball may be colorful and may, to reinforce the Orbits of Influence® model in the minds of the attendees, be decorated graphically with graphic representations similar to that of FIG. 3. The purpose of the Oracle ball is to give one person at a time the ability to speak during the Dialogue and to enable the role of the speaker, or Oracle, to smoothly pass from one attendee to another. The leader may describe the Oracle Ball as similar to the “talking stick” from classroom or scouting traditions, as attendees may be familiar with that concept. The speaker, or Oracle, is to be treated as the “voice of wisdom” by the group during their speaking time, the other group members are to listen respectfully and are not too interrupt one another, or react in a rude or inconsiderate way to any viewpoints expressed.

The Oracle Cards are introduced. These cards are provided to help those attendees who may find it difficult to begin speaking at their turn. The Oracle Cards are “fill in the blank” questions or conversation starters that are fully optional, any participant may draw an Oracle Card if they desire to do so in order to assist them in beginning their own dialogue and expressing their viewpoints. The Oracle Cards may include example phrases and questions such as these:
1. My contribution to the [topic/issue/idea] could be ______.
2. From my point of view, the most important aspect of our [topic/issue/idea] is ______.
3. If I were [choose one: of a different race, sex, religion, nationality, personal belief system] I might see [our topic/idea] as ______.
4. In 25 years, I think [our topic/issue/idea] will be ______, because ______.
5. I think the one thing that would make the biggest impact on [our topic/issue/idea] is
6. If I had the chance to talk to [choose one: an 8 year old, a victim, the president] I would explain [our topic/issue/idea] as ______.
7. In a perfect world, what would [our topic/issue/idea] be . . . or look like? ______.
8. My biggest concern about [our topic/issue/idea] is ______.
9. My most pivotal experience with [our topic/issue/idea] is ______.
10. If I had a magic wand, the first thing I would change about [our issue/topic] would be ______ because ______.
11. If [our issue/topic] were a running shoe, it would be a [style or brand of shoe] because
12. If my personal hero/heroine could advise me on [issue/topic/idea], he or she would say
13. If I were 90 years old, I think I would see [our topic/issue/idea differently because
14. My highest hope for [issue/topic/idea] would be ______.
15. If I could bring in any person in the world—past or present—to help with [issue/topic/idea it would be ______ because he/she ______.
16. If I were 5 years old, I would see [our issue/topic/idea] differently because ______.
17. The biggest benefit to resolving [our topic/issue/idea] would be ______ because ______.
18. If [our topic/issue/idea] were a car, it would be a [brand or type of car] because ______.

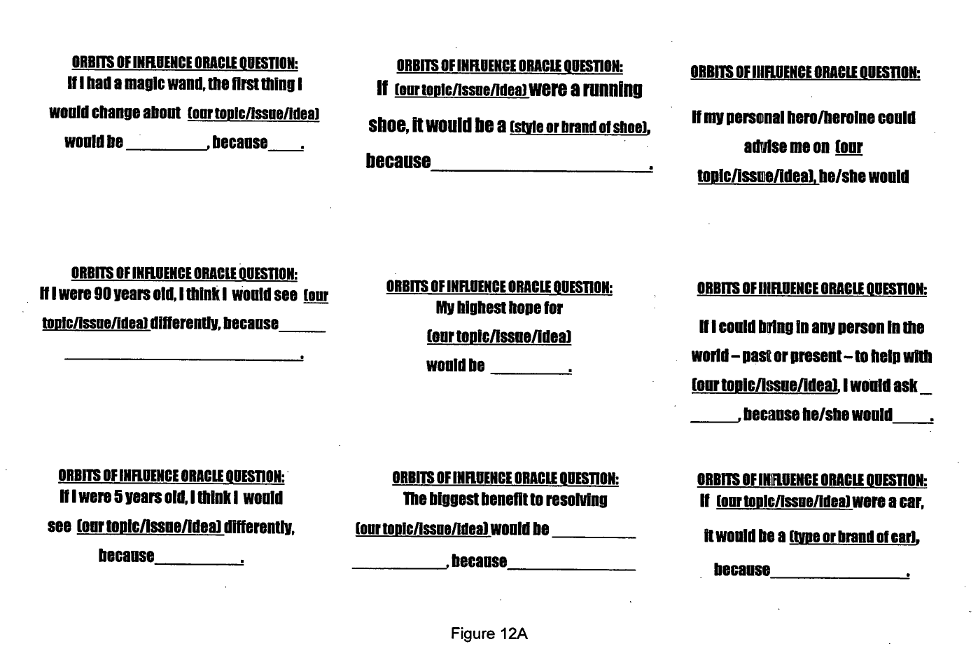

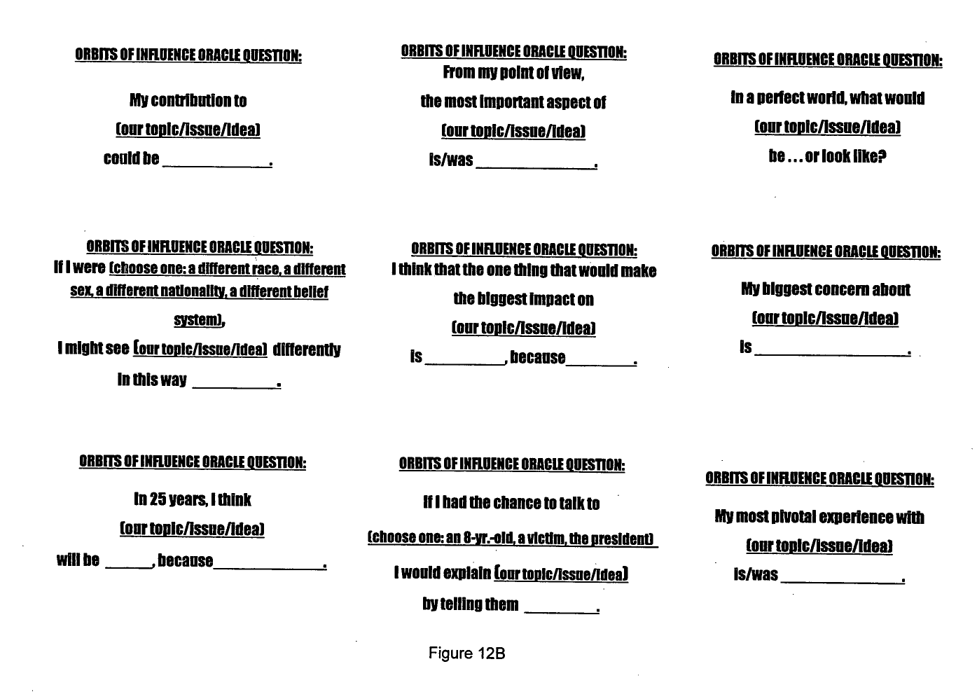

FIGS. 12A and 12B depict exemplary forms for the Oracle Cards, although handouts and other forms could be used.

The group leader now conducts the Dialogue Session following the Leader's guidelines. An initial round of dialogue is conducted with each member of the group participating. Each member is given the Oracle ball for approximately equal time slots of 3-5 minutes. As previously described, the members may choose to use the Oracle Cards to assist them in beginning their dialogue on the topic or issue, or alternatively they may already have a viewpoint or experience they wish to address. In the initial round it is important that each member be given the Oracle Ball and each member participate in the dialogue. The group leader may choose to time the members so as to assure that all members get an approximately equal time to speak.

After the Initial Round, the dialogue continues. The rules for assuring that all of the members are included in the dialogue are as follows: the group leader presents the Oracle ball to one of the volunteers in the group who wish to speak. After a person speaks, he or she will pass the Oracle ball to another. If the Oracle ball is passed between two persons, the first person in that pair may not receive the ball again until at least one other person has had the Oracle ball, so that the dialogue remains inclusive and does not become an exchange between only two members. The group leader will maintain the dialogue by observing fairness in the passing of the Oracle ball and by establishing time limits if necessary to ensure the group as a whole hears an exchange among the whole group. The group leader also participates in the dialogue as it progresses.

As the dialogue session time nears the completion time, the process proceeds to step 85 in FIG. 8. The particular group leader will ask the group if they wish to contribute to the Insights and Inspirations board by recording the special insights or “ah-ha!” moments they observed during their dialogue session. This is optional but it is expected that many groups will choose to make their “Insights” available for the larger group to see, or record topics or issues they want to be addressed in subsequent events. Preferably the facilitator will collect these Insights and Inspirations and use them in a bulletin board provided on line or in a newsletter format to the attendees after the event to enable the attendees, if they choose, to continue additional dialogue or networking on the issues, and to thereby continue to expand their influence after the event.

At the end of the first dialogue session, a second Global Circle is held as indicated by the path back to Step 81 from Step 83. The attendees may be given a short presentation on the dialogue sessions that have just completed, for example group leaders or the facilitator might share certain “insights and inspirations” that were reported during the first dialogue session. The attendees may use the restroom and perhaps enjoy a second beverage during the second Global Circle, which now becomes a repetition of the first process: at Step 81, the attendees again return to the Universe of Ideas wall and self select dialogue topics they wish to dialogue about, the group leaders self select and are issued a group leaders kit, the seating circles or roundtables or parlors for the topic are filled by the method of having the attendees report to the Dialogue Circle table and sign up for a topic, and after enough time has elapsed to enable the attendees to identify and sign up for another dialogue circle, the group leaders again convene their Dialogue Circles for the second dialogue session.

Again the attendees progress through the steps, at step 83 the Dialogue Circles are convened. The number of Dialogue Circle sessions conducted within an event of the invention is also variable, but typically an evening event will include two such sessions, with a 10-15 minute Global Circle or break in between. Following the last session, a final Global Circle will be held. Again the facilitator or other speakers such as the group leaders may wish to review some of the Insights and Inspirations which resulted during the dialogue sessions. Additional discussion at this time could be to announce future events, for example, and to encourage attendees to continue participating in the exchange of ideas by using the post event processes to be described next.

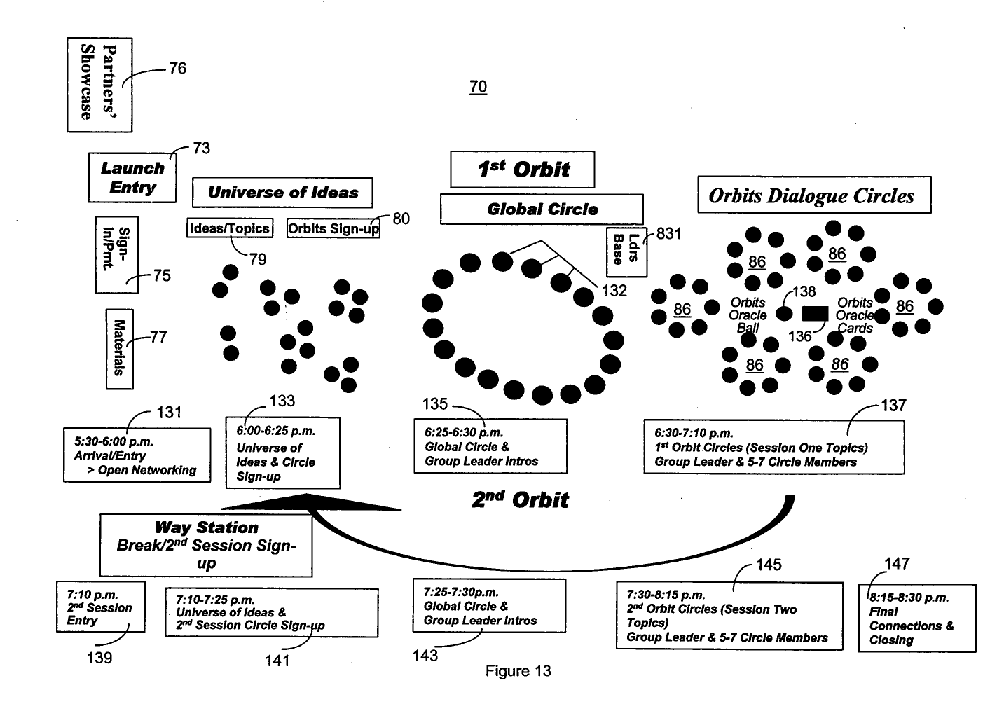

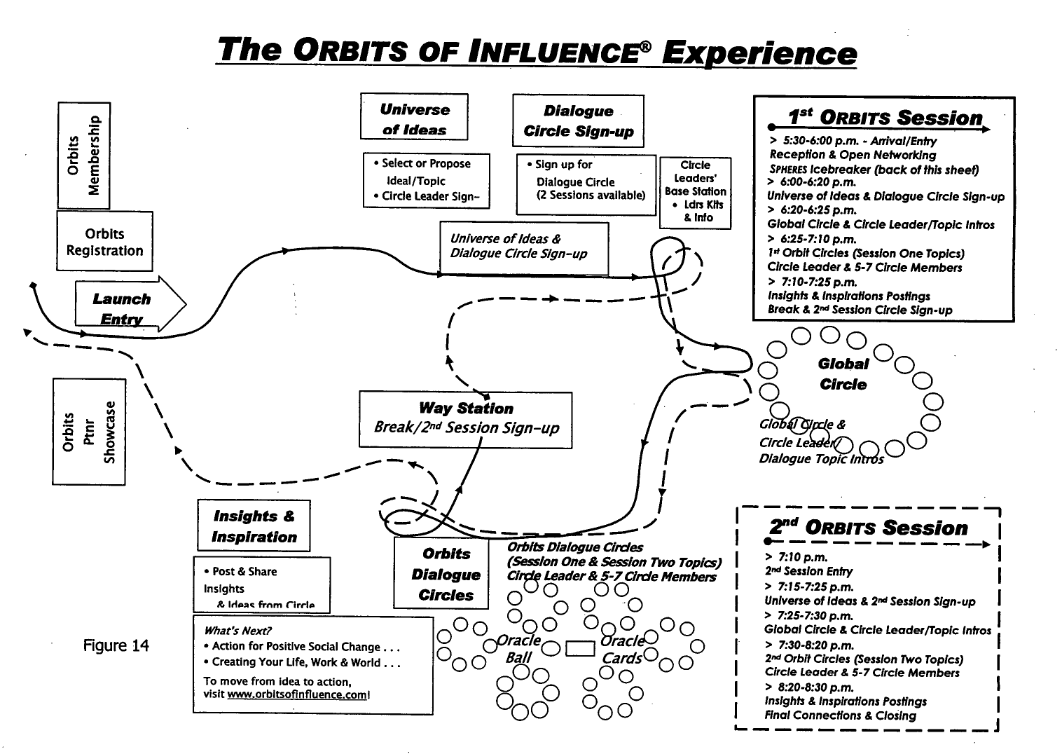

FIG. 14 is a depiction of an explanatory poster which maybe available to attendees to describe the activities which occur within a typical event site such as the one depicted in FIG. 7 and a corresponding timeline of the event, depicted together. Starting at the first time period, 5:30-6:00 pm in this example, the attendees arrive and enter the event through the Launch Entry and have time to enjoy refreshments and for open networking or a brief orientation, if desired. At the second time period from 6-6:20 p.m., the attendees walk about the event space and select topics either from the Universe of Ideas wall, or, if the topic is already selected and displayed at wall 80, sign up for a dialogue group at the Dialogue Circle/Orbits sign up table. The third time period, from 6:20-6:30 pm, is used for the first Global Circle, group leaders are introduced and the concept of expanding the attendees Orbits of Influence is briefly reviewed. The fourth time period, 6:25-7:10 pm, the Dialogue Circles for the first Dialogue Session are convened and the dialogues are conducted by the attendees using the processes and apparatus described above. The process then reiterates as shown by the arrow labeled “2^{nd} Orbit” in FIG. 13. Again the attendees are given a time to self select dialogue topics at the Universe of Ideas wall and to sign up for dialogue at the Orbit Sign-Up table. This time period is, in this example, from 7:10-7:25 pm. Now a second sign up session is conducted from 7:25-7:30 pm and a second Global Circle is briefly conducted, the Group Leaders for the second Dialogue Session are introduced. The second Dialogue session then begins at time 7:30 pm, the Dialogue Circles are convened and in this example from 7:30-8:15 pm the second dialogues are conducted. A final Global Circle is held, for example from 8:15-8:30 pm to review the results and the facilitators may conduct a closing ceremony. The attendees are then free to conduct additional networking and exchanges while they begin to leave the event.

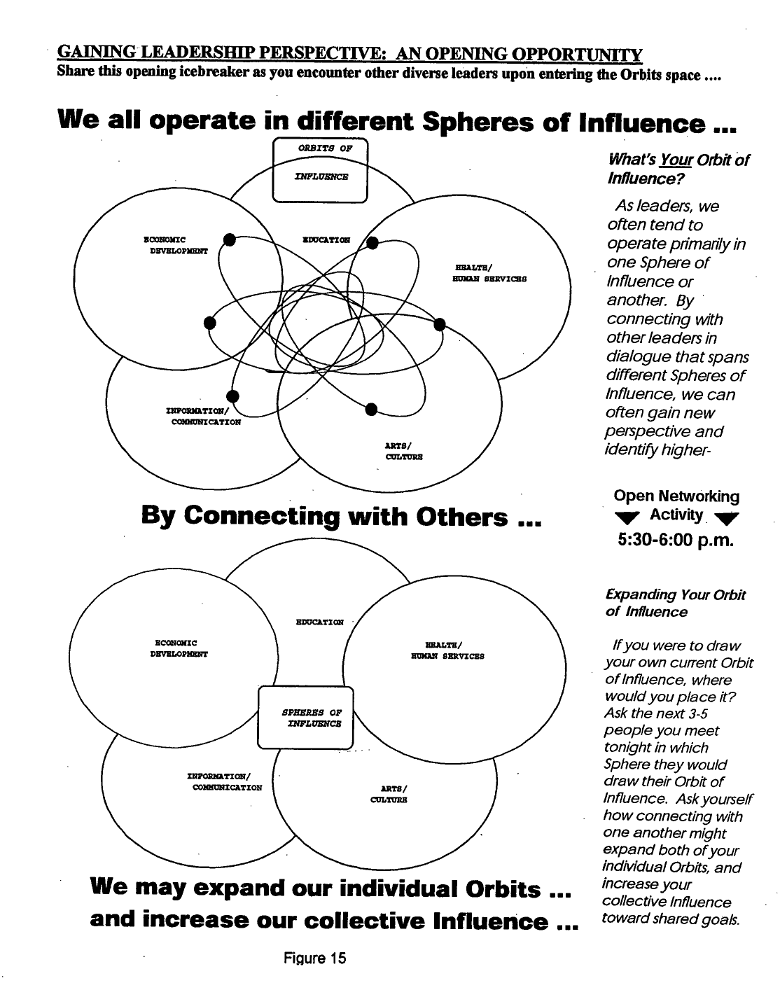

FIG. 15 depicts another poster or handout which maybe made available to attendees at the event. FIG. 15 presents two views of an individuals spheres of influence and explains the purpose of the event and the goal of expanding the attendee's orbits of influence.

After the Orbits of Influence® event is complete, it is desirable to enhance the experience and to continue to expand the influence of the attendees by providing a community discussion forum for those persons who attended a particular event. This may be accomplished most readily by providing a newsgroup or email thread within a facilitator's website. The facilitator may post the topics which were used in the dialogue sessions, and the “Insights and Inspirations” that were reported during those sessions, as part of the website. Attendees may be given a password or account or otherwise be allowed to post new viewpoints or additional insights for other attendees to see and respond to. In this manner additional benefits and ongoing expansion of the collective influence may be maintained by attendees after the event.

In addition to the various materials described above in the Group Leaders kit, a facilitators' kit is provided in another embodiment of the apparatus of the invention which provides all of the tools and materials needed for a facilitator to use the methods described herein to conduct events: to use the programmed system of the invention to plan, to prepare, schedule, promote, set up, facilitate, conduct, and complete a successful event using the methods of the invention to enhance the influence of the attendees as provided above. The list of materials for the facilitators' kit includes some or all of the following, but is not limited to these and additional books, games, and other materials such as banners and artwork may be added to the kit, and such additions or modifications are contemplated by and within the present invention.
1. An Orbits of Influence® banner for the Launch Entry door of the event site. Additional banners may also be provided to use within the site.
2. Portable display walls for the Universe of Ideas wall, the Dialogue Circles Wall, and optional partnership display walls and the Insights and Inspirations wall.
3. Movable placards for the Topics to be displayed on the Universe of Ideas wall, and the Dialogue Circles wall. Blank movable placards for adding additional topics during the event.
4. Printed materials including sample brochures and ad copy, sample flyers, invitations, and newsletters for use in announcing and promoting an event.
5. Nametags and attendees handouts in card or flyer form, for use at the registration table.
6. Banners or placards using the trademarked phrase Orbits of Influence® and having the explanatory graphics related to the orbits concepts, such as generally shown in FIG. 3.
7. A plurality of Group Leaders kits, typically provided in colorful and color coded boxes or colorful bags to use at the event itself. Each Group Leaders kit will contain, as described above, a group leaders guide, Dialogue Goals cards or handouts, Dialogue Guide cards or handouts, Oracle Ball or object as described above, Oracle cards as shown above, note pads for recording insights and inspirations, optionally a time keeping device, evaluation forms, papers, pens, pencils, small whiteboards, table easels, flip charts, and a colorful banner which is color coded and distinctive from the other group kits.
8. Sample forms for use in the event, including colorful removable adhesive note pads or reusable placards for use on the Insights and Inspirations wall.
9. Printed material and software describing how to design and install an events website for the facilitator and how to set up email threads, bulletin boards, newsgroups and the like for use by the attendees before and after the event.
10. Printed materials on how to select topics including suggested survey materials and techniques for surveying potential attendees.
11. Printed materials on how to expand the diversity of the attendees including sample invitations, registration forms and instructions on how to locate and purchase group mailing lists.
12. Printed materials on how to gain the interest of sponsors and how to identify and contact groups and individuals that could benefit from an event.

Preferably, the facilitators kits can be used as part of a franchising or licensing business plan to enable the distribution of the method and apparatus of the invention as a business opportunity. That is, the sale and distribution of these materials can be linked to a licensing program so that in a given region, certain facilitators may purchase and have an exclusive right to conduct events. These facilitators can use the materials to conduct events as a business or perhaps as a charitable activity. Alternatively, larger groups such as corporate or governmental entities may purchase a license and the necessary materials to conduct in house events incorporating the methods and system of the invention within their own organizations on a regular or frequent basis.

1. A method of enhancing influence among members of a diverse group; comprising the steps of:
(a) arranging a meeting of a diverse group of members, each having individual spheres of influence within certain organizations or groups of which they are a member;
(b) identifying and designating a scalable, defined scope or focus for the content and topics, the “Universe of Ideas,” for each gathering in order to fit any size group with any scope of interest;
(c) allowing the members of the diverse group to self-organize into smaller groups to engage in dialogue sessions to address one or more of the topics provided;
(d) the smaller groups simultaneously and autonomously conducting a dialogue on the particular topic or topics they self-selected, led by a group leader from within the smaller group;
(e) the dialogue sessions being conducted so that each member of the smaller group is encouraged to provide his/her own perspective and viewpoints on the topic selected;
(f) the individuals of the smaller groups crossing their spheres of influence such that collectively their spheres of influence are enhanced and expanded;
(g) the smaller groups reforming into the diverse group; and
(h) selectively providing another set of topics for additional dialogue sessions and repeating the steps c-g above to provide additional dialogue sessions and additional enhancing of the groups' spheres of influence.

2. The method of claim 1, and further comprising the steps of:
gathering the members of the diverse group together following any one of the dialogue sessions and having each smaller group report certain features of their dialogue session back to the larger group, thereby increasing the influence of the dialogue on the larger group.

3. The method of claim 1, and further comprising the steps of:
gathering the members of the diverse group together following any one of the dialogue sessions;
having each smaller group report certain features of their dialogue session back to the larger group; and
selectively recording certain features of the dialogue session of the smaller group for future reference, thereby increasing the influence of the dialogue on the larger group.

4. The method of claim 1, and further comprising the steps of:
gathering the members of the diverse group together following any one of the dialogue sessions;
having each smaller group report certain features of their dialogue session back to the larger group; and
selectively reporting certain features of the dialogue session for any one of the smaller groups with the consent of the members of that smaller group to a broader audience which includes at least some members of the larger group and at least some members that were not part of the larger group, thereby increasing the influence of the dialogue on the larger group and enabling the influence of the dialogue on the broader audience.

5. The method of claim 4, and further providing the step of:
recording certain features of the dialogue sessions of any one of the smaller groups for future reference; and
distributing the recordings to a broader audience after the event, thereby enabling the influence of the dialogue on the broader audience.

6. The method of claim 5, and wherein the step of distributing further comprises the step of:
posting the recordings on an internet website accessible by the broader audience after the event.

7. The method of claim 5, and wherein the step of distributing further comprises the step of:
transmitting the recordings to the broader audience by electronic mail after the event.

8. The method of claim 1, wherein the step of arranging a meeting of a diverse group of individuals further comprises the steps of:
identifying groups having members of diverse backgrounds;
sending invitations to the event describing the event as an event to enhance the influence of the attendees;
establishing an interface for the members to register for the event; and
collecting registrations of individuals for the event;

9. The method of claim 8, wherein the step of establishing an interface further comprises the step of establishing an internet website individuals may access using a computer connected to the internet.

10. The method of claim 8 wherein the step of establishing an interface further comprises the step of establishing an automated phone answering system where individuals can leave a message indicating they will attend the event.

11. The method of claim 8 wherein the step of identifying a Universe of Ideas further comprises the steps of collecting information with the registration of individuals indicating particular areas of interest they would like to participate in dialogue about.

12. The method of claim 11 and further comprising the step of identifying individual dialogue topics which are within the scope and context of the Universe of Ideas and which will be available for individuals to exchange dialogue about during the event.

13. The method of claim 1 wherein the step of conducting the dialogue session the so that each member of the smaller group is encouraged to provide their own perspective and viewpoints on the topic selected further comprises the steps of:
providing an Oracle object to the individual who has the right to speak at a given time;
providing Oracle cards which pose dialogue starter statements in question and answer form, the question including the topic for the particular dialogue session;
providing dialogue guidelines to each individual which communicate certain elements of effective dialogue and give advice about starting a dialogue;
providing a timepiece for measuring the time a particular individual is given to speak; and
using the timepiece and Oracle object, allocating a portion of the overall time to a particular individual by providing them with the Oracle object and giving the individual a proportional share of the time period for dialogue in which to speak without interruption from other individuals in the group.

14. Apparatus for use in conducting an event to expand the influence of individuals and the collective influence of a group of individuals, comprising:
banners announcing an event for use at an event site;
portable walls for receiving movable and removable placards indicating topics for dialogue, one wall representing the Universe of Ideas, and another wall representing Dialogue Circles;
seating circles for enabling small groups of attendees at the event to participate in dialogue circles in a game like manner;
for each of the seating circles, an Oracle game piece to be used during the event to indicate which attendee is to speak;
for each of the seating circles, a set of Oracle cards having various statements designed to inspire dialogue;
for each of the seating circles, cards, note cards or moveable placards for recording insights and inspirations;
whereby an event is conducted wherein attendees self select topics by moving placards from the wall representing the Universe of Ideas to the wall representing the Dialogue Circles and subsequently the attendees conduct autonomous dialogue sessions utilizing the Oracle game piece and the Oracle game cards to enhance dialogue with one another and thereby expand their individual and collective influence.

15. The apparatus of claim 14 wherein the Oracle cards for enhancing dialogue further comprise statements in question and answer form in which the question includes the topic selected for dialogue.

16. The apparatus of claim 14, and further comprising providing a time piece for each dialogue circle so that the time an individual speaks may be allocated in a proportional manner.

17. Apparatus for conducting a dialogue session wherein the attendees experience enhanced dialogue, comprising:
an Oracle game piece indicating which member of a group is enabled to speak;
a time keeping device;
a plurality of Oracle cards with conversation inspiring questions printed on them;
dialogue guides providing rules for enhanced dialogue;
dialogue goals providing goals to be achieved for the enhanced dialogue; and
a leaders guide for moderating the enhanced dialogue by leading the attendees through the dialogue in game like fashion.

18. A method for enhancing the influence of individuals by conducting an event the individuals attend, comprising the steps of:
performing steps for identifying a diverse group of individuals to invite to the event;
performing steps for identifying a scope or context, the Universe of Ideas, for dialogue topics to be discussed at the event;
performing steps for identifying specific topics within the Universe of Ideas and
identifying the topics in a manner for display to attendees at the event;
performing steps for conducting the event, those steps further comprising:
(a) performing steps for allowing the individual attendees to enter an event space and to encounter a set of topics for dialogue from which they can select;
(b) performing steps for allowing the individual attendees to select a topic and to attend a dialogue session on that topic, the individuals involved in a dialogue session having autonomously selected that session by selecting the topic;
(c) performing steps for the individuals conducting multiple dialogue sessions on various topics contemporaneously with other dialogue sessions;
(d) performing steps for the individuals exchanging dialogue during the dialogue sessions;
(e) performing steps for presenting certain results or statements from the individual dialogue sessions to the larger group of attendees;
(f) performing steps for repeating at least once the steps be above.

19. The method of claim 18 wherein the step for identifying diverse individuals further comprises the steps of contacting community organizations and obtaining membership lists.

20. The method of claim 18 wherein the step for identifying the Universe of Ideas further comprises the steps of surveying the diverse individuals to generate concepts for use in defining the Universe of Ideas.

21. The method of claim 18 wherein the step for enabling individuals to select a topic for dialogue further comprises the step of allowing individuals to designate themselves as a group leader for the dialogue topic.

22. The method of claim 21 and further comprising the steps of providing the group leader with the materials required to conduct the dialogue session.

23. The method of claim 21 and further comprising the steps of providing the leader with an Oracle ball; Oracle dialogue cards, and dialogue session guidelines for use by the leader and the individuals to conduct the dialogue session.

24. Apparatus for organizing events to enhance the influence of individual attendees, comprising:
software for creating a website publicizing the event;
printed materials for creating invitations to potential attendees to the event;
survey materials for conducting surveys of potential attendees to the event to identify the scope and context of dialogue topics to be used at the event, the Universe of Ideas;
survey materials for conducting surveys of registrants to the event for identifying particular topics to be available for dialogue at the event, the particular topics for dialogue to be within the scope of the Universe of Ideas;
banners for use at the event;
movable placards for use at the event for displaying dialogue topics identified for the event;
a facilitators guide for communicating how to conduct influence enhancing events;
a plurality of dialogue leaders kits for use at such events, each comprising:
an Oracle device for use in identifying an individual with the right to speak during a dialogue session;
a plurality of Oracle cards for use in the dialogue sessions, the Oracle cards communicating dialogue starter ideas in question and answer form, the question containing a reference to the topic for dialogue;
a plurality of dialogue guidelines for use by the individuals in the dialogue session, the guidelines communicating efficient dialogue techniques to the individuals;
a timepiece for use in allocating speaking time to the individuals in a proportional manner; and
materials for recording particular statements, comments or ideas generated during a dialogue session.

25. The apparatus of claim 24 wherein the software further comprises:
software for creating individual access to an electronic bulletin board for each event wherein attendees can continue to exchange dialogue after the event by exchanging electronic messages amongst the attendees.

26. The apparatus of claim 24 wherein the software further comprises:
software for registering individual attendees for the event and includes a survey for generating dialogue topics for the event as individuals register.

27. An apparatus for conducting an event for enhancing the influence of individuals that attend the event, comprising:
means for identifying diverse individuals to invite to attend the event;
means for identifying the scope and context, the Universe of Ideas, for dialogue topics to be used at the event;
means for identifying particular topics for dialogue within the Universe of Ideas to be used at the event;
means for displaying the particular topics for dialogue at the event;
means for enabling attendees at the event to select a dialogue session on a particular topic;
means for enabling a plurality of dialogue sessions to be conducted contemporaneously, further comprising:
means for identifying an individual who has the right to speak at a particular time during the dialogue session;
means for keeping time during the dialogue session to allow speaking time to be proportionally allocated amongst individuals;
means for communicating dialogue conversation starters to the individuals in question and answer form with the dialogue topic forming part of the question;
means for recording certain comments, statements and ideas during the dialogue session;
means for communicating guidelines for effective dialogue to the individuals attending the session; and
means for repeating the dialogue session at least once more.

28. The apparatus of claim 27 and further comprising:
means for presenting the recorded comments, statements and ideas after the dialogue session is completed.
